(19) United States
(12) Patent Application Publication
(10) Pub. No.: US 2003/0009433 A1
(43) Pub. Date: Jan. 9, 2003

(54) Automatic identification of computer program attributes

(76) Inventors: Brian T. Murren, Clifton Park, NY (US); Walter V. Dixon III, Delanson, NY (US); William Gorman, Niskayuna, NY (US)

Correspondence Address: LEE & HAYES PLLC, SUITE 500, 421 W RIVERSIDE, SPOKANE, WA, 99201

(21) Appl. No.: 09/847,067

(22) Filed: Apr. 30, 2001

(51) Int. Cl. G06F 7/00

(52) U.S. Cl. 707/1

(57) ABSTRACT

A set of one or more attributes of a computer program are automatically identified and an indication of the set is output. These attributes are attributes that are to be input to the computer program by a user and/or attributes that are output by the computer program.

### TECHNICAL FIELD

The present invention is directed to computer program testing and input form generation, and more particularly to the automatic identification of computer program attributes.

### BACKGROUND

Computer technology is ever-advancing, resulting in increasingly powerful computers becoming available. The field of computer programming has seized upon these advances and is continually developing increasingly powerful computer programs having a wide range of functionality. Unfortunately, these increasingly powerful computer programs are becoming increasingly large and complex, resulting in significant programmer-time being used to generate and test the programs.

One specific problem found in developing computer programs is the time and expense involved in testing the programs. This problem is exacerbated as programs increase in size and complexity, resulting in prolonged time-consuming testing processes. It would thus be desirable to have a technique to reduce the time and expense involved in testing programs.

Additionally, most computer programs allow for user-input of data as well as the presentation of data to the user. Multiple different screen displays or forms for both the user input of the data as well as the output of the data may be included in a program. Another problem found in developing computer programs is the time and effort involved in designing the various input and output forms for the computer program. This development typically requires the form designer to be knowledgeable as to what data is included on the forms being designed. The form designer may not be involved in the development of the remainder of the program, thus making it difficult and time consuming for him or her to become knowledgeable as to what data is to be included on the forms. It would thus be desirable to have a technique to reduce the time and expense involved in developing input and output presentations for programs.

### SUMMARY

Automatic identification of computer program attributes is described herein.

A set of one or more attributes of a computer program are automatically identified and an indication of the set is output. These attributes are attributes that are to be input to the computer program by a user and/or attributes that are output by the computer program.

### BRIEF DESCRIPTION OF THE DRAWINGS

FIG. 1 illustrates a network system that implements a server application architecture that may be tailored to various domains.

FIG. 2 is a block diagram of the application architecture.

FIG. 3 is a flow diagram illustrating a general operation of the application architecture when handling client requests.

FIG. 4 is a block diagram of an exemplary execution model configured as an asset catalog program that allows a user to view, create, and modify information relating to assets stored in an electronic catalog.

FIG. 5 is a flow diagram of a process for executing the asset catalog program.

FIG. 6 is a block diagram of the program controller used in the execution model of FIG. 4.

FIG. 7 illustrates an exemplary testing and form generation system.

FIG. 8 illustrates an exemplary interaction that can be analyzed by the testing and form generation module of FIG. 7.

FIG. 9 shows an exemplary process for testing and form generation of inputs to a business logic FIG. 10 shows an exemplary process for form generation of outputs from a business logic.

The same reference numbers are used throughout the figures to reference like components and features.

### DETAILED DESCRIPTION

A software architecture specifies distinct layers or modules that interact with each other according to a well-defined specification to facilitate efficient and timely construction of business processes and server applications for many diverse domains. Examples of possible domains include asset management, leasing and lending, insurance, financial management, asset repair, inventory tracking, other business-oriented domains, and so forth. The architecture implements a common infrastructure and problem-solving logic model using a domain framework. By partitioning the software into a hierarchy of layers, individual modules may be readily “swapped out” and replaced by other modules that effectively adapt the architecture to different domains.

With this architecture, developers are able to create different software applications very rapidly by leveraging the common infrastructure. New business models can be addressed, for example, by creating new domain frameworks that “plug” into the architecture. This allows developers to modify only a portion of the architecture to construct new applications, resulting in a fraction of the effort that would be needed to build entirely new applications if all elements of the application were to be constructed.

Exemplary System

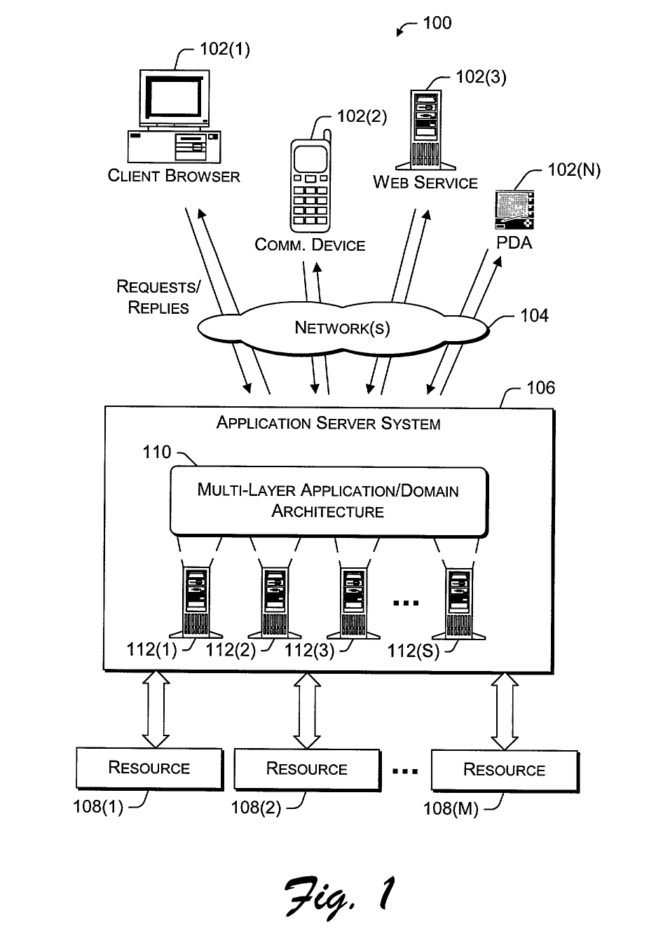

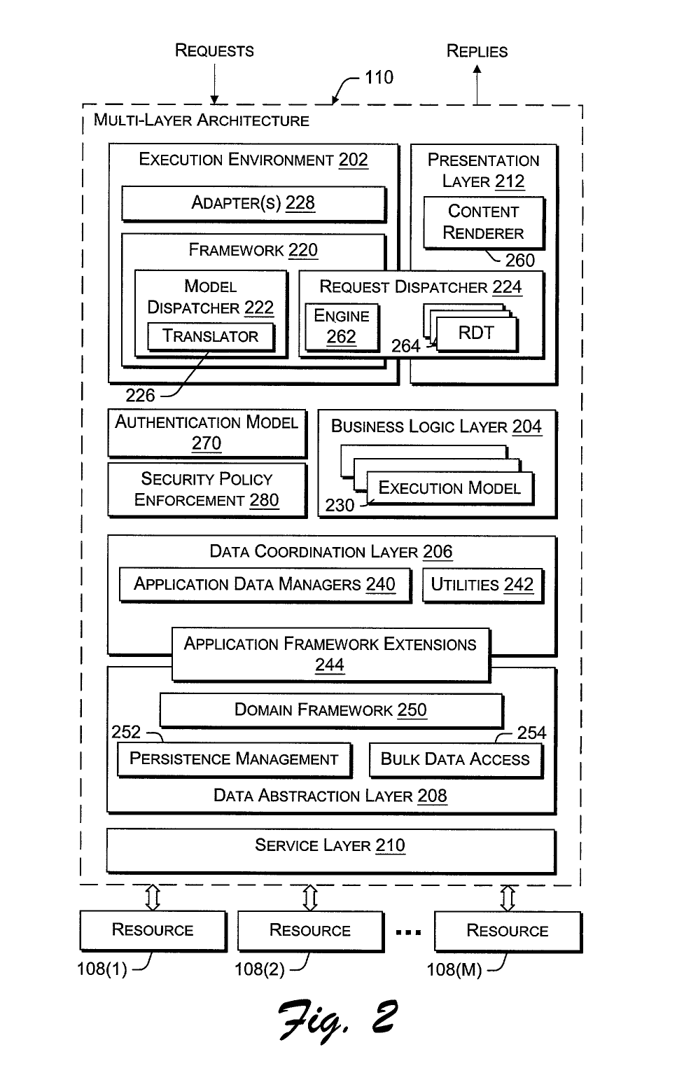

FIG. 1 shows a network system 100 in which the tiered software architecture may be implemented. The system 100 includes multiple clients 102(1), 102(2), 102(3), . . . , 102(N) that submit requests via one or more networks 104 to an application server system 106. Upon receiving the requests, the server system 106 processes the requests and returns replies to the clients 102 over the network(s) 104. In some situations, the server system 106 may access one or more resources 108(1), 108(2), . . . , 108(M) to assist in preparing the replies.

The clients 102 may be implemented in a number of ways, including as personal computers (e.g., desktop, laptop, palmtop, etc.), communications devices, personal digital assistants (PDAs), entertainment devices (e.g., Web-enabled televisions, gaming consoles, etc.), other servers, and so forth. The clients 102 submit their requests using a number of different formats and protocols, depending upon the type of client and the network 104 interfacing a client and the server 106.

The network 104 may be implemented by one or more different types of networks (e.g., Internet, local area network, wide area network, telephone, etc.), including wire-based technologies (e.g., telephone line, cable, etc.) and/or wireless technologies (e.g., RF, cellular, microwave, IR, wireless personal area network, etc.). The network 104 can be configured to support any number of different protocols, including HTTP (HyperText Transport Protocol), TCP/IP (Transmission Control Protocol/Internet Protocol), WAP (Wireless Application Protocol), and so on.

The server system 106 implements a multi-layer software architecture 110 that is tailored to various problem domains, such as asset management domains, financial domains, asset lending domains, insurance domains, and so forth. The multi-layer architecture 110 resides and executes on one or more computers, as represented by server computers 112(1), 112(2), 112(3), . . . 112(S). The tiered architecture 110 may be adapted to handle many different types of client devices 102, as well as new types as they become available. Additionally, the architecture 110 may be readily configured to accommodate new or different resources 108.

The server computers 112 are configured as general computing devices having processing units, one or more types of memory (e.g., RAM, ROM, disk, RAID storage, etc.), input and output devices, and a busing architecture to interconnect the components. As one possible implementation, the servers 112 may be interconnected via other internal networks to form clusters or a server farm, wherein different sets of servers support different layers or modules of the architecture 110. The servers may or may not reside within a similar location, with the software being distributed across the various machines. Various layers of the architecture 110 may be executed on one or more servers. As an alternative implementation, the architecture 110 may be implemented on single computer, such as a mainframe computer or a powerful server computer, rather than the multiple servers as illustrated.

The resources 108 are representative of any number of different types of resources. Examples of resources include databases, websites, legacy financial systems, electronic trading networks, auction sites, and so forth. The resources 108 may reside with the server system 106, or be located remotely. Access to the resources may be supported by any number of different technologies, networks, protocols, and the like.

General Architecture

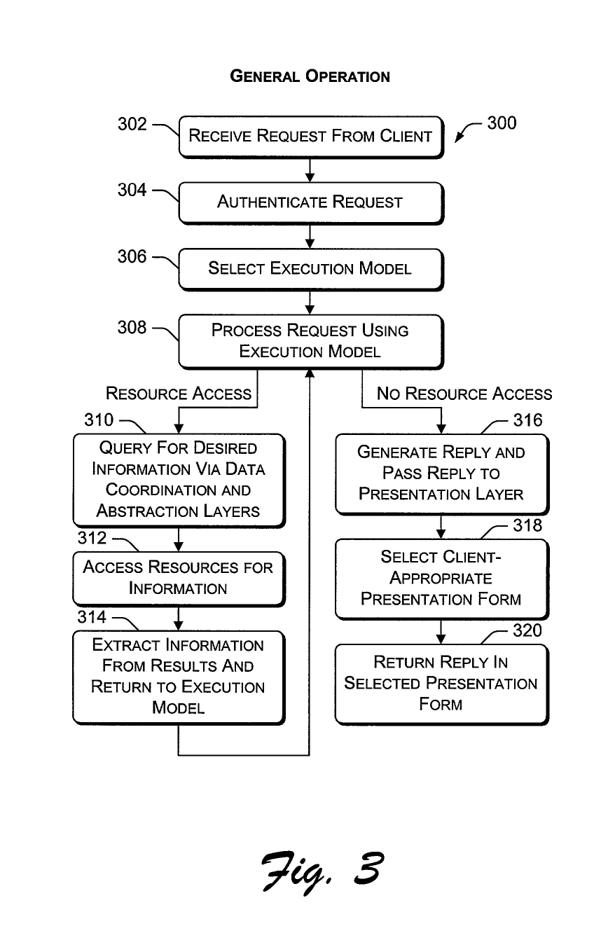

FIG. 2 illustrates one exemplary implementation of the multi-layer architecture 110 that is configured as a server application for a business-oriented domain. The architecture is logically partitioned into multiple layers to promote flexibility in adapting the architecture to different problem domains. Generally, the architecture 110 includes an execution environment layer 202, a business logic layer 204, a data coordination layer 206, a data abstraction layer 208, a service layer 210, and a presentation layer 212. The layers are illustrated vertically to convey an understanding as to how requests are received and handled by the various layers.

Client requests are received at the execution environment 202 and passed to the business logic layer 204 for processing according to the specific business application. As the business logic layer 204 desires information to fulfill the requests, the data coordination layer 206, data abstraction layer 208, and service layer 210 facilitate extraction of the information from the external resources 108. When a reply is completed, it is passed to the execution environment 202 and presentation layer 212 for serving back to the requesting client.

The architecture 110 can be readily modified to (1) implement different applications for different domains by plugging in the appropriate business logic in the business logic layer 204, (2) support different client devices by configuring suitable modules in the execution environment 202 and presentation layer 212, and (3) extract information from diverse resources by inserting the appropriate modules in the data abstraction layer 208 and service layer 210. The partitioned nature of the architecture allows these modifications to be made independently of one another. As a result, the architecture 110 can be adapted to many different domains by interchanging one or more modules in selected layers without having to reconstruct entire application solutions for those different domains.

The execution environment 202 contains an execution infrastructure to handle requests from clients. In one sense, the execution environment acts as a container into which the business logic layer 204 may be inserted. The execution environment 202 provides the interfacing between the client devices and the business logic layer 204 so that the business logic layer 204 need not understand how to communicate directly with the client devices.

The execution environment 202 includes a framework 220 that receives the client requests and routes the requests to the appropriate business logic for processing. After the business logic generates replies, the framework 220 interacts with the presentation layer 212 to prepare the replies for return to the clients in a format and protocol suitable for presentation on the clients.

The framework 220 is composed of a model dispatcher 222 and a request dispatcher 224. The model dispatcher 222 routes client requests to the appropriate business logic in the business logic layer 204. It may include a translator 226 to translate the requests into an appropriate form to be processed by the business logic. For instance, the translator 226 may extract data or other information from the requests and pass in this raw data to the business logic layer 204 for processing. The request dispatcher 224 formulates the replies in a way that can be sent and presented at the client. Notice that the request dispatcher is illustrated as bridging the execution environment 202 and the presentation layer 212 to convey the understanding that, in the described implementation, the execution environment and the presentation layer share in the tasks of structuring replies for return and presentation at the clients.

One or more adapters 228 may be included in the execution environment layer 202 to interface the framework 220 with various client types. As an example, one adapter may be provided to receive requests from a communications device using WAP, while another adapter may be configured to receive requests from a client browser using HTTP, while a third adapter is configured to receive requests from a messaging service using a messaging protocol.

The business logic layer 204 contains the business logic of an application that processes client requests. Generally speaking, the business logic layer contains problem-solving logic that produces solutions for a particular problem domain. In this example, the problem domain is a commerce-oriented problem domain (e.g., asset lending, asset management, insurance, etc.), although the architecture 110 can be implemented in non-business contexts. The logic in the logic layer is therefore application-specific and hence, is written on a per-application basis for a given domain.

In the illustrated implementation, the business logic in the business logic layer 204 is constructed as one or more execution models 230 that define how computer programs process the client requests received by the application. The execution models 230 may be constructed in a variety of ways. One exemplary execution model employs an interaction-based definition in which computer programs are individually defined by a series of one or more interaction definitions based on a request-response model. Each interaction definition includes one or more command definitions and view definitions. A command definition defines a command whose functionality may be represented by an object that has various attributes and that provides the behavior for that command. A view definition defines a view that provides a response to a request.

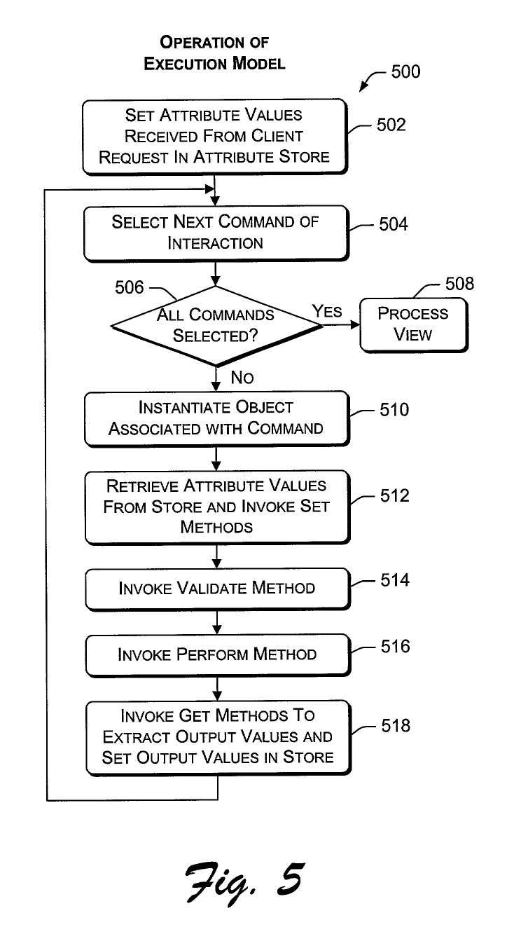

One example of an interaction-based model is a command bean model that employs multiple discrete program modules, called “Command Beans”, that are called for and executed. The command bean model is based on the “Java Bean” from Sun Microsystems, which utilizes discrete Java™ program modules. One particular execution model 230 that implements an exemplary program is described below beneath the heading “Business Logic Layer” with reference to FIGS. 4-6.

Other examples of an execution model include an action-view model and a use case model. The action-view model employs action handlers that execute code and provide a rendering to be served back to the client. The use case model maps requests to predefined UML (Unified Modeling Language) cases for processing.

The data coordination layer 206 provides an interface for the business logic layer 204 to communicate with a specific domain framework 250 implemented in the data abstraction layer 208 for a specific problem domain. In one implementation, the framework 250 utilizes a domain object model to model information flow for the problem domain. The data coordination layer 206 effectively partitions the business logic layer 204 from detailed knowledge of the domain object model as well as any understanding regarding how to obtain data from the external resources.

The data coordination layer 206 includes a set of one or more application data managers 240, utilities 242, and framework extensions 244. The application data managers 240 interface the particular domain object model in the data abstraction layer 208 into a particular application solution space of the business logic layer 204. Due to the partitioning, the execution models 230 in the business logic layer 204 are able to make calls to the application data managers 240 for specific information, without having any knowledge of the underlying domain or resources. The application data managers 240 obtain the information from the data abstraction layer 208 and return it to the execution models 230. The utilities 242 are a group of reusable, generic, and low-level code modules that developers may utilize to implement the interfaces or provide rudimentary tools for the application data managers 240.

The data abstraction layer 208 maps the domain object model to the various external resources 108. The data abstraction layer 208 contains the domain framework 250 for mapping the business logic to a specific problem domain, thereby partitioning the business applications and application managers from the underlying domain. In this manner, the domain framework 250 imposes no application-specific semantics, since it is abstracted from the application model. The domain framework 250 also does not dictate any functionality of services, as it can load any type of functionality (e.g., Java™ classes, databases, etc.) and be used to interface with third-party resources.

Extensions 244 to the domain framework 250 can be constructed to help interface the domain framework 250 to the application data managers 240. The extensions can be standardized for use across multiple different applications, and collected into a library. As such, the extensions may be pluggable and removable as desired. The extensions 244 may reside in either or both the data coordination layer 206 and the data abstraction layer 208, as represented by the block 244 straddling both layers.

The data abstraction layer 208 further includes a persistence management module 252 to manage data persistence in cooperation with the underlying data storage resources, and a bulk data access module 254 to facilitate access to data storage resources. Due to the partitioned nature of the architecture 110, the data abstraction layer 208 isolates the business logic layer 204 and the data coordination layer 206 from the underlying resources 108, allowing such mechanisms from the persistence management module 252 to be plugged into the architecture as desired to support a certain type of resource without alteration to the execution models 230 or application data managers 240.

A service layer 210 interfaces the data abstraction layer 208 and the resources 108. The service layer 210 contains service software modules for facilitating communication with specific underlying resources. Examples of service software modules include a logging service, a configuration service, a serialization service, a database service, and the like.

The presentation layer 212 contains the software elements that package and deliver the replies to the clients. It handles such tasks as choosing the content for a reply, selecting a data format, and determining a communication protocol. The presentation layer 212 also addresses the “look and feel” of the application by tailoring replies according to a brand and user-choice perspective. The presentation layer 212 is partitioned from the business logic layer 204 of the application. By separating presentation aspects from request processing, the architecture 110 enables the application to selectively render output based on the types of receiving devices without having to modify the logic source code at the business logic layer 204 for each new device. This allows a single application to provide output for many different receiving devices (e.g., web browsers, WAP devices, PDAs, etc.) and to adapt quickly to new devices that may be added in the future.

In this implementation, the presentation layer 212 is divided into two tiers: a presentation tier and a content rendering tier. The request dispatcher 224 implements the presentation tier. It selects an appropriate data type, encoding format, and protocol in which to output the content so that it can be carried over a network and rendered on the client. The request dispatcher 224 is composed of an engine 262, which resides at the framework 220 in the illustrated implementation, and multiple request dispatcher types (RDTs) 264 that accommodate many different data types, encoding formats, and protocols of the clients. Based on the client device, the engine 262 makes various decisions relating to presentation of content on the device. For example, the engine might select an appropriate data encoding format (e.g. HTML, XML, EDI, WML, etc.) for a particular client and an appropriate communication protocol (e.g. HTTP, Java™ RMI, CORBA, TCP/IP, etc.) to communicate the response to the client. The engine 262 might further decide how to construct the reply for visual appearance, such as selecting a particular layout, branding, skin, color scheme, or other customization based on the properties of the application or user preference. Based on these decisions, the engine 262 chooses one or more dispatcher types 264 to structure the reply.

A content renderer 260 forms the content rendering tier of the presentation layer 212. The renderer 260 performs any work related to outputting the content to the user. For example, it may construct the output display to accommodate an actual width of the user's display, elect to display text rather than graphics, choose a particular font, adjust the font size, determine whether the content is printable or how it should be printed, elect to present audio content rather than video content, and so on.

With the presentation layer 212 partitioned from the execution environment 202, the architecture 110 supports receiving requests in one format type and returning replies in another format type. For example, a user on a browser-based client (e.g., desktop or laptop computer) may submit a request via HTTP and the reply to that request may be returned to that user's PDA or wireless communications device using WAP. Additionally, by partitioning the presentation layer 212 from the business logic layer 204, the presentation functionality can be modified independently of the business logic to provide new or different ways to serve the content according to user preferences and client device capabilities.

The architecture 110 may include one or more other layers or modules. One example is an authentication model 270 that performs the tasks of authenticating clients and/or users prior to processing any requests. Another example is a security policy enforcement module 280 that supports the security of the application. The security enforcement module 280 can be implemented as one or more independent modules that plug into the application framework to enforce essentially any type of security rules. New application security rules can be implemented by simply plugging in a new system enforcement module 280 without modifying other layers of the architecture 110.

General Operation

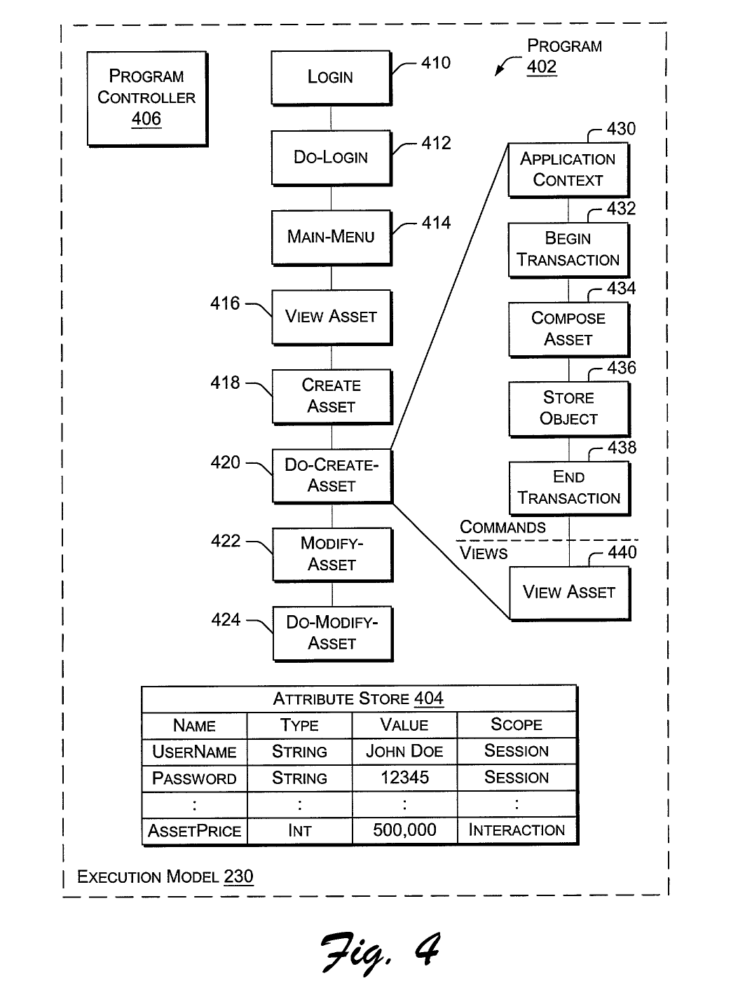

FIG. 3 shows an exemplary operation 300 of a business domain application constructed using the architecture 110 of FIGS. 1 and 2. The operation 300 is implemented as a software process of acts performed by execution of software instructions. Accordingly, the blocks illustrated in FIG. 3 represent computer-readable instructions, that when executed at the server system 106, perform the acts stipulated in the blocks.

To aid the discussion, the operation will be described in the context of asset management, wherein the architecture 110 is configured as a server application executing on the application server system 106 for an asset management domain. Additionally, for discussion purposes, suppose a user is equipped with a portable wireless communications device (e.g., a cellular phone) having a small screen with limited display capabilities and utilizing WAP to send/receive messages over a wireless cellular network. The user submits a request for information on a particular asset, such as the specification of a turbine engine or the availability of an electric pump, from the wireless communications device.

At block 302, requests from various clients are received at the execution environment layer 202. Depending on the client type, one or more adapters 228 may be involved to receive the requests and convert them to a form used internally by the application 110. In our example, the execution environment layer 202 receives the request from the wireless cellular network. An adapter 228 may be utilized to unwrap the request from its WAP-based packet for internal processing.

At block 304, the execution framework 202 may pass the request, or data extracted from the request, to the authentication model 270 for authentication of the client and/or user. If the requestor is not valid, the request is denied and a service denied message (or other type of message) is returned to the client. Assuming the request is valid, the authentication model 270 returns its approval.

At block 306, the model dispatcher 222 routes the request to one or more execution models 230 in the business logic layer 204 to process the client request. In our example, the model dispatcher 222 might select selects an execution model 230 to retrieve information on the particular asset. A translator 226 may be invoked to assist in conforming the request to a form that is acceptable to the selected execution model.

At block 308, the execution model 230 begins processing the request. Suppose, for example, that the selected execution model is implemented as a command bean model in which individual code sequences, or “command beans”, perform discrete tasks. One discrete task might be to initiate a database transaction, while another discrete task might be to load information pertaining to an item in the database, and a third discrete task might be to end the transaction and return the results.

The execution model 230 may or may not need to access information maintained at an external resource. For simple requests, such as an initial logon page, the execution model 230 can prepare a reply without querying the resources 108. This is represented by the “No Resource Access” branch in FIG. 3. For other requests, such as the example request for data on a particular asset, the execution model may utilize information stored at an external resource in its preparation of a reply. This is illustrated by the “Resource Access” branch.

When the execution model 230 reaches a point where it wishes to obtain information from an external resource (e.g., getting asset specific information from a database), the execution model calls an application data manager 240 in the data coordination layer 206 to query the desired information (i.e., block 310). The application data manager 240 communicates with the domain framework 250 in the data abstraction layer 208, which in turn maps the query to the appropriate resource and facilitates access to that resource via the service layer 210 (i.e., block 312). In our example, the domain framework is configured with an asset management domain object model that controls information flow to external resources-storage systems, inventory systems, etc.—that maintain asset information.

At block 314, results are returned from the resource and translated at the domain framework 250 back into a raw form that can be processed by the execution model 230. Continuing the asset management example, a database resource may return specification or availability data pertaining to the particular asset. This data may initially be in a format used by the database resource. The domain framework 250 extracts the raw data from the database-formatted results and passes that data back through the application data managers 240 to the execution model 230. In this manner, the execution model 230 need not understand how to communicate with the various types of resources directly, nor understand the formats employed by various resources.

At block 316, the execution model completes execution using the returned data to produce a reply to the client request. In our example, the command bean model generates a reply containing the specification or availability details pertaining to the requested asset. The execution model 230 passes the reply to the presentation layer 212 to be structured in a form that is suitable for the requesting client.

At block 318, the presentation layer 212 selects an appropriate format, data type, protocol, and so forth based on the capabilities of the client device, as well as user preferences. In the asset management example, the client device is a small wireless communication device that accepts WAP-based messages. Accordingly, the presentation layer 212 prepares a text reply that can be conveniently displayed on the small display and packages that reply in a format supported by WAP. At block 320, the presentation layer 212 transmits the reply back to the requesting client using the wireless network.

Business Logic Layer

The business logic layer 204 contains one or more execution models that define how computer programs process client requests received by the application. One exemplary execution model employs an interaction-based definition in which computer programs are individually defined by a series of one or more interaction definitions based on a request-response model. Each interaction definition includes command definitions and view definitions. A command definition defines a command whose functionality may be represented by an object that has various attributes and that provides the behavior for that command. A view definition defines a view that provides a response to a request.

Each interaction of a computer program is associated with a certain type of request. When a request is received from the model dispatcher 222, the associated interaction is identified to perform the behavior of the commands defined by that interaction. The execution model automatically instantiates an object associated with each command defined in a command definition. Prior to performing the behavior of a command, the execution model prepares the instantiated object by identifying one or more input attributes of that object (e.g., by retrieving the class definition of the object) and setting the input attributes (e.g., by invoking set methods) of the object based on the current value of the attributes in an attribute store.

After setting the attribute values, the execution model performs the behavior of the object (e.g., by invoking a perform method of the object). After the behavior is performed, the execution model extracts the output attributes of the object by retrieving the values of the output attributes (e.g., by invoking get methods of the object) and storing those values in the attribute store. Thus, the attribute store stores the output attributes of each object that are then available to set the input attributes of other objects.

The execution model may serially perform the instantiation, preparation, performance, and extraction for each command. Alternatively, the execution of commands can be performed in parallel depending on the data dependencies of the commands. Because the execution model automatically prepares an object based on the current values in the attribute store and extracts attribute values after performing the behavior of the object, a programmer does not need to explicitly specify the invocation of methods of objects (e.g., “object.setAttribute1=15”) when developing a computer program to be executed by the execution model.

FIG. 4 shows an exemplary execution model 230 configured for an asset catalog application that allows a user to view, create, and modify information relating to assets (e.g., products) stored in an electronic catalog. The model 230 includes an asset catalog program 402, an attribute store 404, and a program controller 406. The asset catalog program 402 includes eight interactions: login 410, do-login 412, main-menu 414, view-asset 416, create-asset 418, do-create-asset 420, modify-asset 422, and do-modify-asset 424. The controller 406 executes the program 402 to perform the various interactions. One exemplary implementation of the controller is described below in more detail with reference to FIG. 6.

Upon receiving a request, the controller 406 invokes the corresponding interaction of the program 402 to perform the behavior and return a view so that subsequent requests of the program can be made. The do-create-asset interaction 420, for example, is invoked after a user specifies the values of the attributes of a new asset to be added to the asset catalog. Each interaction is defined by a series of one or more command definitions and a view definition. Each command definition defines a command (e.g., object class) that provides a certain behavior. For instance, the do-create-asset interaction 420 includes five command definitions—application context 430, begin transaction 432, compose asset 434, store object 436, and end transaction 438—and a view definition named view asset 440.

When the do-create-asset interaction 420 is invoked, the application context command 430 retrieves the current application context of the application. The application context may be used by the interaction to access certain application-wide information. The begin transaction command 432 indicates that a transaction for the asset catalog is beginning. The compose asset command 434 creates an object that identifies the value of the attributes of the asset to be added to the asset catalog. The store object command 436 stores an entry identified by the created object in the asset catalog. The end transaction command 438 indicates that the transaction to the asset catalog has ended. The view asset view 440 prepares a response (e.g., display page) to return to the user.

The attribute store 404 contains an entry for each attribute that has been defined by any interaction of the application that has been invoked. The attribute store identifies a name of the attribute, a type of the attribute, a scope of the attribute, and a current value of the attribute. For example, the last entry in the attribute store 404 has the name of “assetPrice”, with a type of “integer”, a value of “500,000”, and a scope of “interaction”. The scope of an attribute indicates the attribute's life. An attribute with the scope of “interaction” (also known as “request”) has a life only within the interaction in which it is defined. An attribute with the scope of “session” has a life only within the current session (e.g., logon session) of the application. An attribute with the scope of “application” has life throughout the duration of an application.

When the program controller 406 receives a request to create an asset (e.g., a do-create-asset request), the controller invokes the do-create-asset interaction 420. The controller first instantiates an application context object defined in the interaction command 430 and prepares the object by setting its attributes based on the current values of the attribute store 404. The controller then performs the behavior of the object by invoking a perform method of the object and extracts the attribute values of the object by getting the attribute values and storing them in the attribute store 404.

Next, the program controller 406 instantiates a begin transaction object defined by the interaction command 432 and prepares the object by setting its attribute values based on the current values of the attribute store 404. It then performs the behavior of the object by invoking a perform method of the object and extracts the attribute values of the object by getting the attribute values and storing them in the attribute store. The controller 406 repeats this process for a compose-asset object instantiated according to command 434, the store-object object instantiated according to command 436, and the end transaction object instantiated according to command 438. The controller 406 then invokes the view asset 440 to retrieve the values of the attributes of the asset from the attribute store 404 for purposes of presenting those attribute values back to the client.

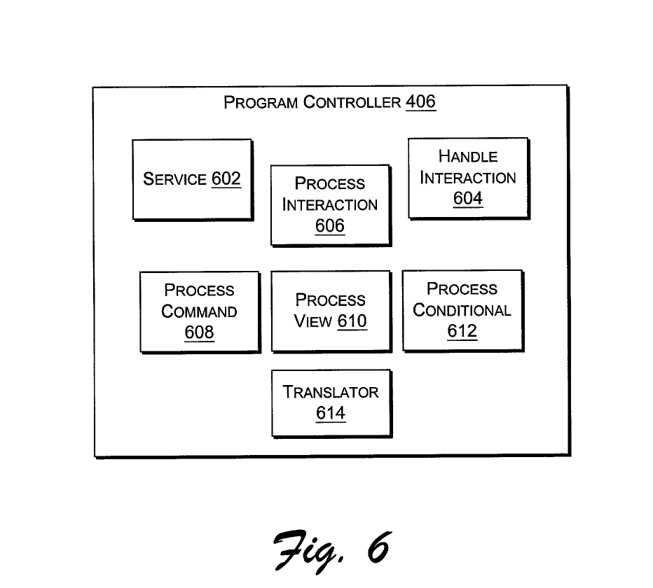

FIG. 5 shows a process 500 implemented by the program controller 406 of the execution model 230 when executing an interaction-based program, such as program 402. The process 500 is implemented in software and hence, the illustrated blocks represent computer-readable instructions, that when executed at the server system 106, perform the stated acts.

At block 502, the controller 406 sets the attribute values from the request in the attribute store 404. For example, a view-asset request may include a value for an “assetID” attribute that uniquely identifies an asset currently stored in the asset catalog. The controller then loops through each command of the interaction associated with the request. At block 504, the controller selects the next command of the interaction associated with the request, starting with the first command. If all commands have already been selected (i.e., the “yes” branch from block 506), the controller 406 processes the view defined in the view definition of the interaction and returns the response to the presentation layer 212 (i.e., block 508).

On the other hand, if not all of the commands have been selected (i.e., the “no” branch from block 506), the controller instantiates an object associated with the selected command (i.e., block 510). The object class associated with the command is specified in the command definition of the interaction. In block 512, the controller 406 prepares the object by retrieving the values of the input attributes of the object from the attribute store 404 and invoking the set methods of the object to set the values of the attributes. At block 514, the controller invokes a validate method of the object to determine whether the current values of the input attributes of the object will allow the behavior of the object to be performed correctly. If the validate method indicates that the behavior cannot be performed, the controller generates an exception and skips further processing of the commands of the interaction.

At block 516, the controller invokes the perform method of the object to perform the behavior of the object. At block 518, the controller extracts the values of the output attribute of the object by invoking the get methods of the object and setting the values of the corresponding attributes in the attribute store 404. The controller then loops to block 504 to select the next command of the interaction.

FIG. 6 shows one exemplary implementation of the controller 406 in more detail. It includes multiple components that are configured according to the request-response model where individual components receive a request and return a response. The controller 406 includes a service component 602 that is invoked to service a request message. The service component 602 stores the value of any attributes specified in the request in the attribute store 404. For example, the component may set the current value of a URL attribute as indicated by the request. Once the attribute values are stored, the service component 602 invokes a handle interaction component 604 and passes on the request. It is noted that the service component will eventually receive a response in return from the handle interaction component 604, which will then be passed back to the presentation layer 212 for construction of a reply to be returned to the client.

The handle interaction component 604 retrieves, from the program database, the interaction definition for the interaction specified in the request. The handle interaction component 604 then invokes a process interaction component 606 and passes the request, response, and the interaction definition.

The process interaction component 606 processes each command and view of the interaction and returns a response. For a given descriptor (i.e., command, view, or conditional) specified in the interaction, the process interaction component identifies the descriptor and invokes an appropriate component for processing. If the descriptor is a command, the process interaction component 606 invokes a process command component 608 to process the command of interaction. If the descriptor is a view, the process interaction component 606 invokes a process view component 610 to process the view of the interaction. If the descriptor is a conditional, the process interaction component 606 invokes a process conditional component 612 to process the conditional of the interaction.

When processing a command, the process command component 608 instantiates the object (e.g., as a “Java bean” in the Java™ environment) for the command and initializes the instantiated object by invoking an initialization method of the object. The process command component invokes a translator component 614 and passes the instantiated object to prepare the object for performing its behavior. A translator component is an object that provides a prepare method and an extract method for processing an object instantiated by the process command component to perform the command. Each command may specify the translator that is to be used for that command. If the command does not specify a translator, a default translator is used.

The translator component 614 sets the attribute values of the passed object based on the current attribute values in the attribute store 404. The translator component 614 identifies any set methods of the object based on a class definition of the object. The class definition may be retrieved from a class database or using a method provided by the object itself. When a set method is identified, the translator component identifies a value of the attribute associated with a set method of the object. The attribute store is checked to determine whether a current value for the attribute of the set method is defined. If the current value of the attribute is defined in the attribute store, the attribute value is retrieved from the attribute store, giving priority to the command definition and then to increasing scope (i.e., interaction, session, and then application). The component performs any necessary translation of the attribute value, such as converting an integer representation of the number to a string representation, and passes back the translated value. When all methods have been examined, the translator component 614 returns control to the process command component 608.

The process command component 608 may also validate the object. If valid, the component performs the behavior of the object by invoking the perform method of the object. The component once again invokes the translator and passes the object to extract the attribute values of the object and store the current attribute values in the attribute store 404.

When processing a view, the process view component 610 either invokes a target (e.g., JSP, ASP, etc.) or invokes the behavior of an object that it instantiates. If a class name is not specified in the definition of the view, the process view component 610 retrieves a target specified in the view definition and dispatches a view request to the retrieved target. Otherwise, if a class name is specified, the process view component 610 performs the behavior of an object that it instantiates. The process view component 610 retrieves a translator for the view and instantiates an object of the type specified in the view definition. The process view component 610 initializes the object and invokes the translator to prepare the object by setting the values of the attributes of the object based on the attribute store. The process view component 610 validates the object and performs the behavior of the object. The process view component 610 then returns.

When processing a conditional, the process conditional component 612 interprets a condition to identify the descriptors that should be processed. The component may interpret the condition based on the current values of the attributes in the attribute store. Then, the process conditional component 612 recursively invokes the process interaction component 606 to process the descriptors (command, view, or conditional) associated with the condition. The process conditional component 612 then returns.

One exemplary form of a program implemented as a document type definition (DTD) is illustrated in Table 1. The interactions defining the program are specified in an XML (“eXtensible Markup Language”) file.

TABLE 1

| | |
|---|---|
| 1. | <!ELEMENT program (translator*,command*,view*,interaction*)> |
| 2. | <!ATTLIST program |
| 3. | name ID #REQUIRED |
| 4. | > |
| 5. | |
| 6. | <!ELEMENT translator EMPTY> |
| 7. | <!ATTLIST translator |
| 8. | name ID #REQUIRED |
| 9. | class CDATA #REQUIRED |
| 10. | default (true\|false) “false” |
| 11. | > |
| 12. | |
| 13. | <!ELEMENT translator-ref EMPTY> |
| 14. | <!ATTLIST translator-ref |
| 15. | name IDREF #REQUIRED |
| 16. | > |
| 17. | |
| 18. | <!ELEMENT command (translator-ref*, attribute*)> |
| 19. | <!ATTLIST command |
| 20. | name ID #REQUIRED |
| 21. | class CDATA #REQUIRED |
| 22. | > |
| 23. | |
| 24. | <!ELEMENT command-ref (attribute*)> |
| 25. | <!ATTLIST command-ref |
| 26. | name IDREF #REQUIRED |
| 27. | type (default\|finally) “default” |
| 28. | > |
| 29. | |
| 30. | <!ELEMENT attribute EMPTY> |
| 31. | <!ATTLIST attribute |
| 32. | name ID #REQUIRED |
| 33. | value CDATA #IMPLIED |
| 34. | get-name CDATA #IMPLIED |
| 35. | set-name CDATA #IMPLIED |
| 36. | scope (application\|request\|session) “request” |
| 37. | > |
| 38. | |
| 39. | <!ELEMENT view> |
| 40. | <!ATTLIST view |
| 41. | name ID #REQUIRED |
| 42. | target CDATA #REQUIRED |
| 43. | type (default\|error) “default” |
| 44. | default (true\|false) “false” |
| 45. | > |
| 46. | |
| 47. | <!ELEMENT view-ref> |
| 48. | <!ATTLIST view-ref |
| 49. | name IDREF #REQUIRED |
| 50. | > |
| 51. | |
| 52. | <!ELEMENT if(#PCDATA)> |
| 53. | <!ELEMENT elsif(#PCDATA)> |
| 54. | <!ELEMENT else EMPTY> |
| 55. | <!ELEMENT conditional (if?, elsif*, else*, command-ref*, view-ref*, conditional*)> |
| 56. | |
| 57. | !ELEMENT interaction (command-ref*,view-ref*,conditional*)> |
| 58. | <!ATTLIST interaction |
| 59. | name ID #REQUIRED |
| 60. | > |

Lines 1-4 define an program tag, which is the root tag of the XML file. The program tag can include translator, command, view, and interaction tags. The program tag includes a name attribute that specifies the name of the program. Lines 6-11 define a translator tag of the translator, such as translator 614. The name attribute of the translator tag is a logical name used by a command tag to specify the translator for that command. The class attribute of the translator tag identifies the class for the translator object. The default attribute of the translator tag indicates whether this translator is the default translator that is used when a command does not specify a translator.

Lines 13-16 define a translator-ref tag that is used in a command tag to refer back to the translator to be used with the command. The name attribute of the translator-ref tag identifies the name of the translator to be used by the command. Lines 18-22 define a command tag, which may include translator-ref tags and attribute tags. The translator-ref tags specify names of the translators to be used by this command and the attribute tags specify information relating to attributes of the command. The name attribute of the command tag provides the name of the command. The class attribute of the command tag provides the name of the object class that provides the behavior of the command.

Lines 24-28 define a command-ref tag that is used by an interaction tag (defined below) to specify the commands within the interaction. The command reference tag may include attribute tags. The name attribute of the command-ref tag specifies the logical name of the command as specified in a command tag. The type attribute of the command-ref tag specifies whether the command should be performed even if an exception occurs earlier in the interaction. The value of “finally.” means that the command should be performed.

Lines 30-37 define an attribute tag, which stipulates how attributes of the command are processed. The name attribute of the attribute tag specifies the name of an attribute. The value attribute of the attribute tag specifies a value for the attribute. That value is to be used when the command is invoked to override the current value for that attribute in the attribute store. The get-name attribute of the attribute tag specifies an alternate name for the attribute when getting an attribute value. The set-name attribute of the attribute tag specifies an alternate name for the attribute when setting an attribute value. The scope attribute of the attribute tag specifies whether the scope of the attribute is application, request (or interaction), or session.

Lines 39-45 define a view tag that stipulates a view. The name attribute of the view tag specifies the name of the view. The target attribute of a view tag specifies the JSP target of a view. The type attribute of the view tag specifies whether the view should be invoked when there is an error. The default attribute of the view tag specifies whether this view is the default view that is used when an interaction does not explicitly specify a view.

Lines 47-50 define a view-ref tag, which is included in interaction tags to specify that the associated view is to be included in the interaction. The name attribute of the view-ref tag specifies the name of the referenced view as indicated in a view tag. Lines 52-55 define tags used for conditional analysis of commands or views. A conditional tag may include an “if” tag, an “else if” tag, an “else” tag, a command-ref tag, a view-ref tag, and a conditional tag. The data of the “if” tag and the “else if” tag specify a condition (e.g., based on attribute values in the attribute store) that defines the commands or view that are to be conditionally performed when executing interaction.

Lines 57-60 define an interaction tag, which defines a sequence of command, view, or conditional tags of an interaction. The interaction tag may include command-ref, view-ref and conditional tags. The name attribute of the interaction tag identifies the name of the interaction. The requests passed into the execution model specify the name of the interaction to execute.

Table 2 provides an example XML file for the asset catalog program 402 illustrated in FIG. 4 and described above. Line 1 includes a program tag with the name of the program “asset catalog”. Lines 2-3 specify the default translator for the program. Lines 5-11 define the various commands associated with the program. For example, as indicated by line 7, the command named “login” is associated with the class “demo.cb.Login.” Whenever a login command is performed, an object of class “demo.cb.Login” is used to provide the behavior.

Lines 13-20 define the views of the program. For example, line 14 illustrates that the view named “view-asset” (i.e., view 440 in FIG. 4) is invoked by invoking the target named “html/view-assetjsp.” Lines 23-119 define the various interactions that compose the program. For example, lines 42-53 define the view-asset interaction 416 as including command-ref tags for each command defined in the interaction. The conditional tag at lines 47-52 defines a conditional view such that if a login user has administrator permission, the “view-asset-admin” view is invoked; otherwise, the “view-asset” view is invoked. Lines 88-90 illustrate the use of an attribute tag used within a command tag. The attribute tag indicates that the attribute named “object” is an input attribute of the command that corresponds to the attribute named “asset” in the attribute store 404.

TABLE 2

| | |
|---|---|
| 1. | <program name=“asset catalog”> |
| 2. | <translator name=“default-trans” class=“com.ge.dialect.cb.DefaultTranslator” |
| 3. | default=“true”/> |
| 4. | |
| 5. | <command name=“app-ctx” class=“demo.cb.AppCtx”/> |
| 6. | <command name=“begin-tx” class=“demo.cb.BeginTx”/> |
| 7. | <command name=“login” class=“demo.cb.Login”/> |
| 8. | <command name=“load-asset” class=“demo.cb.LoadAsset”/> |
| 9. | <command name=“compose-asset” class=“demo.cb.ComposeAsset”/> |
| 10. | <command name=“store-object” class=“demo.cb.StoreObject”/> |
| 11. | <command name=“end-tx” class=“demo.cb.EndTx”/> |
| 12. | |
| 13. | <view name=“error-view” target=“html/error.jsp” type=“error” default=“true”/> |
| 14. | <view name=“view-asset” target=“html/view-asset.jsp”/> |
| 15. | <view name=“view-asset-admin” target=“html/view-asset-admin.jsp”/> |
| 16. | <view name=“create-asset” target=“html/create-asset.jsp”/> |
| 17. | <view name=“modify-asset” target=“html/modify-asset.jsp”/> |
| 18. | <view name=“login” target=“html/login.jsp”/> |
| 19. | <view name=“login-error” target=“html/login.jsp” type=“error”/> |
| 20. | <view name=“main-menu” target=“html/main-menu.jsp”/> |
| 21. | |
| 22. | |
| 23. | <interaction name=“login”> |
| 24. | <view-ref name=“login”/> |
| 25. | </interaction> |
| 26. | |
| 27. | <interaction name=“do-login”> |
| 28. | <command-ref name=“app-ctx”/> |
| 29. | <command-ref name=“begin-tx”/> |
| 30. | <command-ref name=“login”> |
| 31. | <attribute name=“loginUser” scope=“session”/> |
| 32. | </command-ref> |
| 33. | <command-ref name=“end-tx” type=“finally”/> |
| 34. | <view-ref name=“main-menu”/> |
| 35. | <view-ref name=“login-error”/> |
| 36. | </interaction> |
| 37. | |
| 38. | <interaction name=“main-menu”> |
| 39. | <view-ref name=“main-menu”/> |
| 40. | </interaction> |
| 41. | |
| 42. | <interaction name=“view-asset”> |
| 43. | <command-ref name=“app-ctx”/> |
| 44. | <command-ref name=“begin-tx”/> |
| 45. | <command-ref name=“load-asset”/> |
| 46. | <command-ref name=“end-tx” type=“finally”/> |
| 47. | <conditional> |
| 48. | <if>(loginUser != void) &amp;&amp; loginUser.hasPermission(“admin”)</if> |
| 49. | <view-ref name=“view-asset-admin”/> |
| 50. | <else/> |
| 51. | <view-ref name=“view-asset”/> |
| 52. | </conditional> |
| 53. | </interaction> |
| 54. | |
| 55. | <interaction name=“create-asset”> |
| 56. | <view-ref name=“create-asset”/> |
| 57. | </interaction> |
| 58. | |
| 59. | <interaction name=“do-create-asset”> |
| 60. | <command-ref name=“app-ctx”/> |
| 61. | <command-ref name=“begin-tx”/> |
| 62. | <command-ref name=“compose-asset”/> |
| 63. | <command-ref name=“store-object”> |
| 64. | <attribute name=“object” get-name=“asset”/> |
| 65. | </command-ref> |
| 66. | <command-ref name=“end-tx” type=“finally”/> |
| 67. | <conditional> |
| 68. | <if>(loginUser != void) &amp;&amp; loginUser.hasPermission(“admin”)</if> |
| 69. | <view-ref name=“view-asset-admin”/> |
| 70. | <else/> |
| 71. | <view-ref name=“view-asset”/> |
| 72. | </conditional> |
| 73. | </interaction> |
| 74. | |
| 75. | <interaction name=“modify-asset”> |
| 76. | <command-ref name=“app-ctx”/> |
| 77. | <command-ref name=“begin-tx”/> |
| 78. | <command-ref name=“load-asset”/> |
| 79. | <command-ref name=“end-tx” type=“finally”/> |
| 80. | <view-ref name=“modify-asset”/> |
| 81. | </interaction> |
| 82. | |
| 83. | <interaction name=“do-modify-asset”> |
| 84. | <command-ref name=“app-ctx”/> |
| 85. | <command-ref name=“begin-tx”/> |
| 86. | <command-ref name=“load-asset”/> |
| 87. | <command-ref name=“compose-asset”/> |
| 88. | <command-ref name=“store-object”> |
| 89. | <attribute name=“object” get-name=“asset”/> |
| 90. | </command-ref> |
| 91. | <command-ref name=“end-tx” type=“finally”/> |
| 92. | <conditional> |
| 93. | <if>(loginUser != void) &amp;&amp; loginUser.hasPermission(“admin”)</if> |
| 94. | <view-ref name=“view-asset-admin”/> |
| 95. | <else/> |
| 96. | <view-ref name=“view-asset”/> |
| 97. | </conditional> |
| 98. | </interaction> |
| 99. | |
| 100. | |
| 101. | <interaction name=“view-error2”> |
| 102. | <conditional> |
| 103 | <if>“A”.equals(“B”)</if> |
| 104. | <command-ref name=“begin-tx”/> |
| 105. | <command-ref name=“load-asset”/> |
| 106. | <command-ref name=“end-tx” type=“finally”/> |
| 107. | <elsif>“NEVER”.equals(“EQUAL”)</elsif> |
| 108. | <command-ref name=“load-asset”/> |
| 109. | <command-ref name=“end-tx” type=“finally”/> |
| 110. | </conditional> |
| 111. | <view-ref name=“view-asset”/> |
| 112. | </interaction> |
| 113. | |
| 114. | |
| 115. | <interaction name=“view-error”> |
| 116. | <command-ref name=“load-asset”/> |
| 117. | <command-ref name=“end-tx” type=“finally”/> |
| 118. | <view-ref name=“view-asset”/> |
| 119. | </interaction> |
| 120. | |
| 121. | </program> |

Automatic Testing and Form Generation

The business logic in business logic layer 204 of FIG. 2 can use one or more forms to be presented to the user that allow user input to the business logic and/or presentation of data from the business logic to the user. The business logic can be accessed and analyzed in order to automatically generate one or more of these forms. The input forms can then be used to allow user inputs to the business logic, thereby testing its functionality. Additionally, the analysis process can automatically detect some errors in the business logic and identify them to a tester, allowing the detected problems to be corrected without having to identify them by data inputs via forms.

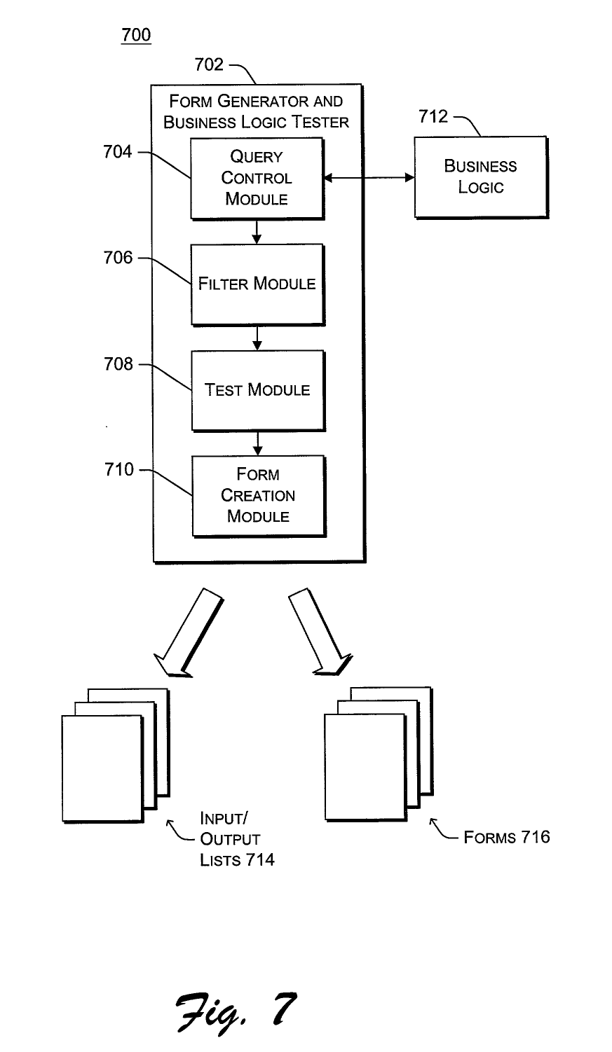

FIG. 7 illustrates an exemplary testing and form generation system 700. A testing and form generation module 702 includes a query control module 704, a filter module 706, a test module 708, and a form creation module 710. The query control module 704 accesses a business logic 712 to obtain the interactions for the business logic 712. This access can be accomplished in a variety of different manners. In one implementation, the query control module 704 communicates requests via the execution environment 202 of FIG. 2 to the business logic 712, which is implemented as one or more of the execution models 230 of the business logic layer 204. Alternatively, the business logic 712 may be loaded into or otherwise retrieved independent of the architecture 110 of FIG. 2. For example, once the business logic 712 is written, the file(s) that include the interactions for the business logic 712 can be made available to the query control module 704.

Once the interactions for the business logic 712 are obtained, the query control module 704 analyzes the command definition(s) and view definition(s) of each interaction in order to identify the methods or operations used by each definition in the interaction. Each command or view definition can include zero or more methods or operations that it executes when invoked. The exact nature of these methods or operations will vary based on the particular interaction and the particular program the interaction is part of. Each command or view definition also includes an interface that allows the definition to be queried for these methods or operations. Thus, by querying each definition in an interaction, the query control module 704 can identify all of the methods used by the various command and view definitions in the interaction. When queried, the command or view definition returns an indication of each method or operation it executes when instantiated, as well as an indication of each type of attribute(s) associated with the method or operation. This process of obtaining information about the definition (meta-data for the definition) is referred to generally as “introspection”, or in Java programming “reflection”.

Alternatively, the query control module 704 may analyze interactions in other manners in order to identify the methods used by the various command and view definitions of an interaction. The specific manner in which interactions are analyzed can vary, depending on the manner in which the interactions and their definitions are implemented. For example, the definitions may be implemented as a set of objects, the code of which can be analyzed (e.g., line by line) to identify the methods that are invoked by the object definition when instantiated. By way of another example, the definitions may be implemented as one or more procedures or functions, and the code of these procedures or functions analyzed (e.g., line by line) to identify the methods that are invoked by the procedures or functions when executed.

The testing and form generation module 702 maintains an indication of the order in which the methods exist within the interaction and within the various definitions of the interaction. In one implementation, this order is identified by the command or view definition when it returns the indicator of the method(s) for that definition. For example, the order in which these methods are identified by the definition is the order they occur in the definition. By maintaining an indication of this ordering, determinations can subsequently be made as to which methods are executed (when the interaction is invoked) before which other methods in the interaction.

The query control module 704 then communicates methods identified for an interaction to the filter module 706. The information communicated to the filter module 706 includes an identification of the method (e.g., its name) as well as any attributes of the method. The filter module 706 identifies selected methods for forwarding to the test module 708. In one implementation, the filter module 706 identifies those methods that are responsible for obtaining attribute values (e.g., “get” methods) and those methods that are responsible for setting or storing attribute values (e.g., “set” methods).

The test module 708 analyzes the methods it receives and attempts to match up the set methods with the get methods. The test module 708 tries to identify, for each set method, a corresponding preceding get method. A set method corresponds to a particular preceding get method if the two methods refer to the same attribute.

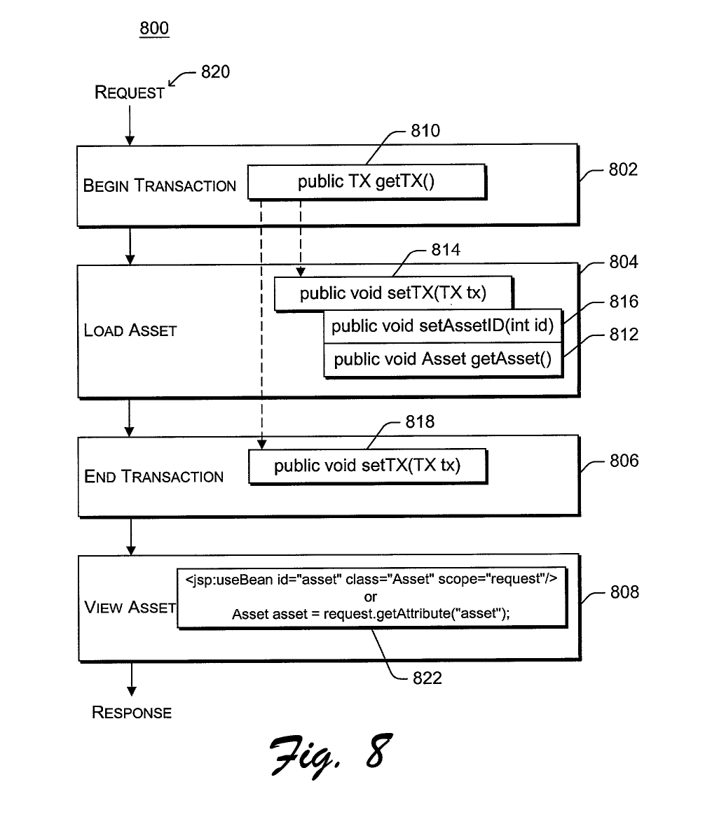

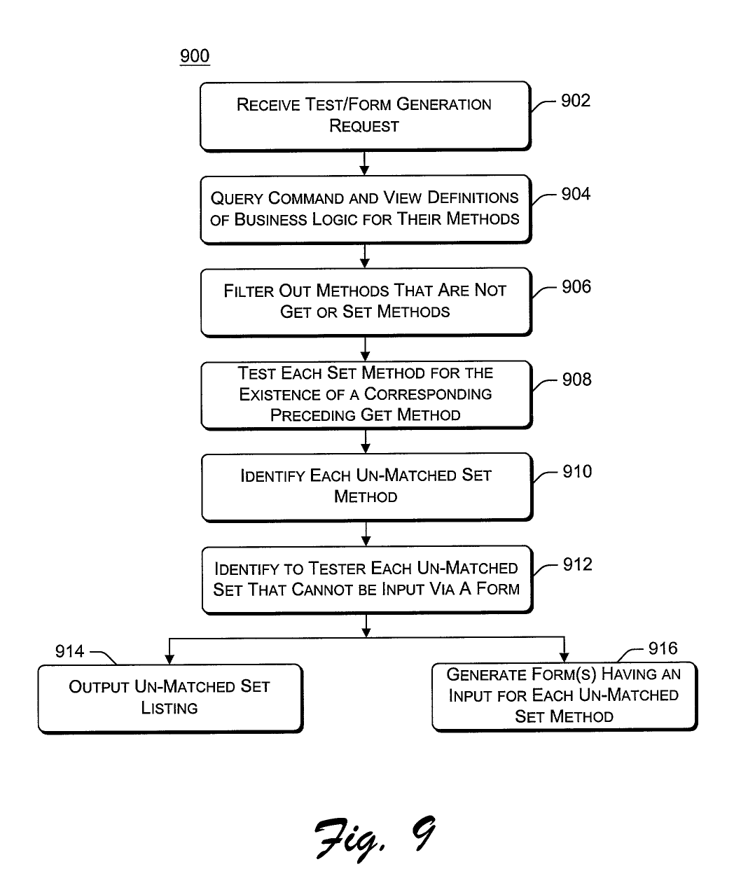

FIG. 8 illustrates an exemplary interaction 800 that can be analyzed by the testing and form generation module 702. The interaction 800 is a view-asset interaction including three command definitions (begin transaction 802, load asset 804, and end transaction 806) and a view definition 808. In the interaction 800, two get methods are identified: “getTX” method 810, and “getAsset” method 812. Similarly, three set methods are identified: “setTX” method 814, “setAssetID” method 816, and “setTX” method 818. Other methods may also be included in the definitions 802-808, but these other methods are filtered out by the filter module 706 and not identified to the test module 708.

The test module 708 analyzes the various set and get methods 810-818 and attempts to identify matching or corresponding methods. A get method and set method correspond to each other if the get method precedes (in either the same definition or a preceding definition of the interaction) the set method and the two methods refer to the same attribute (e.g., the methods have the same name (ignoring the “get” and “set” portions of the names)). Thus, the “getTX” method 810 and the “setTX” method 818 correspond to one another, but the two set methods 814 and 818 do not correspond to one another (one is not a get method) and the “getAsset” method 812 and “setTX” method 818 do not correspond to one another because the attributes are different (one refers to the “Asset” attribute while the other refers to the “TX” attribute).

By identifying matching or corresponding set and get methods, the test module 708 can determine which of the set methods in the interaction, if any, do not have values for their attributes loaded by a get method in that interaction. For these set methods that do not have values assigned to their attributes from elsewhere within the interaction, the testing and form generation module 702 assumes that the values are loaded from the received request 820. Thus, any form generated by the testing and form generation module 702 is to include a field to load these values (if possible, as discussed below).

For example, the “setTX” method exists in both the load asset definition 804 and the end transaction definition 806 (methods 814 and 818, respectively). The “getTX” method 810 exists in the preceding begin transaction definition 802, so the test module 708 does not identify the “TX” attribute as being input as part of the request 820. However, the load asset definition 804 also includes the “setAssetID” method 816, and no preceding rule in the interaction 800 includes a “getAssetID” method. Thus, the test module 708 identifies the “AssetID” attribute as an attribute that is to be obtained from a form input (e.g., a user input), and thus a corresponding field is to be included in the form for the “AssetID” attribute.

In one implementation, the test module 708 flags various conditions it detects from analyzing the methods of the interaction. These conditions that are flagged are used to indicate to a tester whether the interaction is a “well-formed” interaction and is expected to function properly, or whether the interaction has one or more errors that may cause it to function improperly.

The existence of a set method without a corresponding preceding get method may optionally be flagged to the tester. This allows the tester to be notified of what values the interaction is expecting to receive via the input request 820. By identifying these to the tester, the tester may be able to identify one or more values that he or she was not expecting to have to input via the request 820, and thus potential problems with the coding of the interaction.

Additionally, the test module 708 analyzes the types of values it identifies as to be received by the interaction via the request 820. The test module 708 analyzes the value types to determine whether they are values that can be input by a user via a form (e.g., integer or floating point numbers, a character or string of characters, etc.). Any value type that cannot be input by a user via a form (e.g., an object) is flagged to the tester. For example, the test module 708 identifies the “AssetID” as being an attribute with a value that is to be received via the request 820 as discussed above. The test module 708 further analyzes the “setAssetID” method 816 and determines (based on the “int” portion indicating the type of value the attribute is) that the value for the AssetID attribute is an integer. Integers can be input via a form and thus the value for the AssetID attribute can be received via the request 820. However, the value for “Asset” in the “getAsset” method 812 is an object and thus could not be input by a user on a form and cannot be received via the request 820. Thus, if a “setAsset” method existed in the interaction 800 without a preceding “getAsset” method, then the “setAsset” method would be flagged to the tester. The test module 708 may know that the “Asset” attribute is an object, or simply that it is not defined as a type of value that can be input via a form.

Additional conditions may also be flagged to the tester. For example, the filter module 706 may not filter out all non-set and non-get methods. Rather, all of the methods may be communicated to the test module 708 for it to analyze. In this situation, the test module 708 can analyze the methods of the interaction 800 and identify any get method that loads an attribute that is not used by any subsequent method (a subsequent set method or other method). This get method can be flagged to the tester to identify a possible problem with the interaction 800 (e.g., the wrong attribute may be identified in the get method, or the get method may simply be unnecessary as the loaded value is not used by the interaction 800).

The testing module 708 may optionally identify outputs of the interaction 800. The testing module 708 can identify outputs based on the view definition(s) included in an interaction. Different types of outputs can be identified. In one implementation, the testing module 708 simply outputs a title for each output page (e.g., one output page per view definition) identifying a name of the view definition or the interaction it is part of. Alternatively, the testing module 708 may identify types of information that are output by the interaction, based on the contents of the view definition(s) of the asset. For example, the view definition 808 of the interaction 800 includes an indication of an “asset” that is to be presented to the user as a result of the interaction 800.

This attribute name (“asset”) can be identified to the tester as an output of the interaction 800.

Returning to FIG. 7, the testing and form generation module 702 generates a list 714 of inputs and/or outputs for each interaction the module 702 analyzes. The list 714 can take multiple forms. In one implementation, all of the inputs to the analyzed interaction(s) and all of the outputs from the analyzed interaction(s) are included on the list 714. Alternatively, only those inputs and/or outputs that the module 702 has detected as being potentially problematic are included on the list 714. Thus, for example, an interaction that has an integer input for an attribute via a form would not have that attribute included on the list 714, but an interaction that would need an object input for an attribute via a form would have that attribute included on the list 714.

The list 714 can be formatted in a variety of different manners. For example, each interaction may be included on the list along with an identification of each input and/or output (or only potentially problematic inputs) for that interaction. Such an organization allows the tester to readily identify where potential problems may exist. Alternatively, other formats could be used, such as an alphabetical listing by interaction and/or method name, a listing of the methods in order of their appearance in the interaction or business logic, and so forth.

The test module 708 may also provide the results of its analysis to the form creation module 710 to automatically generate forms 716 based on the results of the analysis. The form creation module 710 may generate input forms and/or outputs forms. The forms generated by the creation module 710 are referred to as “skeleton” forms—they provide a basic form for the input (or output) of information. These skeleton forms typically do not have fancy displays, but rather provide just the basic information for the form. The forms can be written in any of a variety of manners, such as HTML, XML, a propriety language, etc.

The skeleton forms 716 created by the form creation module 710 can be used for multiple functions. One function is that the forms 716 can be used as a basis for generating final forms to be used for the application (e.g., in presentation layer 212 of FIG. 2). Another function is that the forms 716 can be used to test the business logic 712. These forms allow the tester to input data to the business logic 712 and have it function as test data for the business logic.

In order to generate an input form, the form creation module 710 identifies each attribute that is to be received as part of the input request for the corresponding interaction. The module 710 automatically creates a label for each attribute (e.g., the name of the attribute) and a data input field for the attribute. The type of data to be input for the attribute is known to the creation module 710 based on the type indication in the method (e.g., the “int” indication of the “setAssetID” method 816 of FIG. 8 indicating an integer type). In one implementation, the module 710 is programmed with the various type indications used by the business logic 712 (e.g., “int” for integer, “char” for character, “bool” for boolean, “string” for a string of characters, etc.). The module 710 also adds a user-selectable “submit” or “ok” button that allows the user of the form to submit the data he or she has filled out in the form.

Using the example interaction 800 of FIG. 8, the form creation module 710 generates an input form 716 including an input field for the AssetID attribute and a “submit” button. The following code illustrates an exemplary input form generated by the creation module 710 based on the interaction 800 of FIG. 8:

<HTML>
<FORM>

<INPUT TYPE=“integer” NAME=“AssetID”>
<INPUT TYPE=“submit” NAME=“validate” VALUE=“validate” >

</FORM>
</HTML>

In order to generate an output form, the form creation module 710 identifies each attribute that is output from the interaction. The module 710 automatically creates a label for each attribute (e.g., the name of the attribute) and an output portion for the content of that attribute (whatever it may be when executed). A form is then created that simply lists each attribute label and output from the interaction.

Using the example interaction 800 of FIG. 8, the form creation module 710 generates an output form 716 that includes an identification of the “asset” object output. The following code illustrates an exemplary output form generated by the creation module 710 based on the interaction 800 of FIG. 8:

<HTML>

<TABLE>
<TR>

<TD>AssetID:</TD>
<TD><% ((Asset)request.getAttribute(“asset”)).getID() %></TD>

</TR>
</TABLE>

</HTML>

The testing and form generation module 702 operates on each of the interactions in the business logic 712. Given the manner in which programs and interactions are defined, as discussed above, the testing and form generation module 702 can readily identify each interaction in the program, which command and view definitions are part of the interaction, and which other interactions may be led to from any other interaction. Thus, the testing and form generation module 702 can generate a set of input and output lists 714, and input and output forms 716, for each of the interactions in the business logic 712. A set of all forms for the business logic 712 can thus be automatically created by the testing and form generation module 702.

By way of example, the program 402 of FIG. 4 includes multiple interactions 410-424. The testing and form generation module 702 automatically accesses the command and view definitions of each of the interactions 410-424 and generates an output (e.g., list(s) 714 and/or form(s) 716) for each of the interactions 410-424.

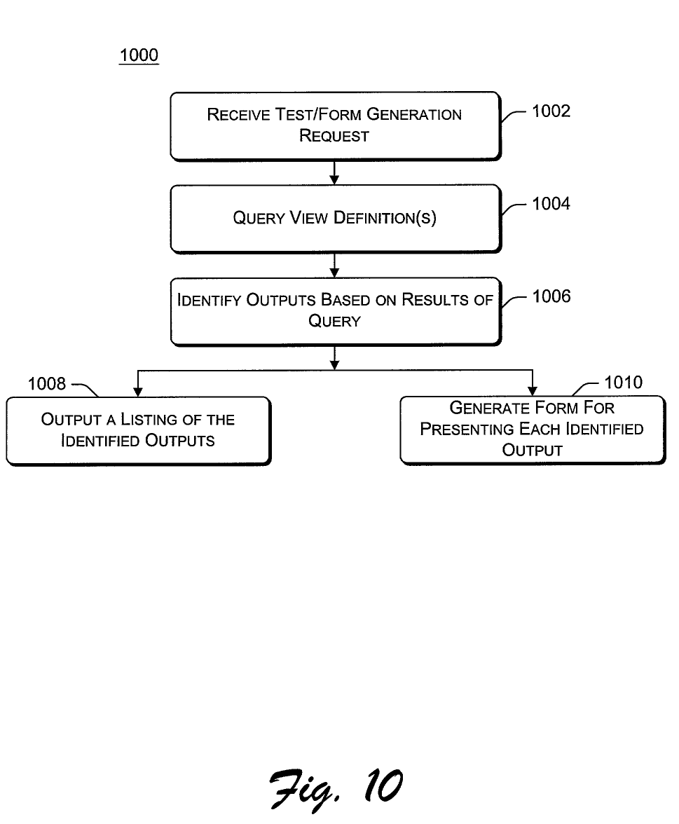

FIG. 9 shows an exemplary process 900 for testing and form generation of inputs to a business logic. The process 900 is implemented as a software process of acts performed by execution of software instructions. Accordingly, the blocks illustrated in FIG. 9 represent computer-readable instructions, that when executed, perform the acts stipulated in the blocks.

In block 902, a request to perform a test and/or generate a form for inputs is received. This may be a request identifying a particular interaction(s) of a business logic, or alternatively a blanket request covering all interactions of the business logic.

In block 904, in response to the request of block 902, the command and view definition(s) of the business logic are queried for their methods. This querying is performed for each of the command and view definitions of each interaction identified in the request.

In block 906, the group of methods identified from querying the command and view definitions are filtered to exclude the methods that are not get or set methods. Alternatively, this filtering may be inherent in the querying of block 904 (that is, the command and view definitions may be configured to return only their get and set methods in response to a query).

In block 908, each set method is tested for the existence of a corresponding preceding get method within the same interaction. In block 910, each unmatched set method is identified (that is, each set method in the interaction for which there is no corresponding preceding get method).

In block 912, each unmatched set method that cannot be input by a form (e.g., an object) is identified to the tester.

The process can then take one or both of two different courses. The first course that may be taken is block 914, where the group of unmatched sets, if any, is output as a list. Alternatively, as discussed above, all of the set methods may be output. The second course that may be taken is block 916, where a form(s) is generated having an input field for each unmatched set for an attribute that can be input by the user. One or more forms may be generated for each interaction. Which course is taken can be identified in a variety of manners, such as included in the request received in block 902, pre-programmed within the testing and form generation module, a preference of the testing and form generation module set by the tester, and so forth.

FIG. 10 shows an exemplary process 1000 for form generation of outputs from a business logic. The process 1000 is implemented as a software process of acts performed by execution of software instructions. Accordingly, the blocks illustrated in FIG. 10 represent computer-readable instructions, that when executed, perform the acts stipulated in the blocks.

In block 1002, a request to perform a test and/or generate a form for outputs is received. This may be a request identifying a particular interaction(s) of a business logic, or alternatively a blanket request covering all interactions of the business logic.

In block 1004, in response to the request of block 1002, the view definition(s) of the business logic are queried (analogous to the querying of command definitions for methods) to determine any attributes identified in the view definition(s). This querying is performed for each view definition(s) of each interaction identified in the request. In block 1006, the output(s) for each interaction, if any, are identified based on the results of querying the view definition(s).

The process can then take one or both of two different courses. The first course that may be taken is block 1008, where output(s) to the interaction(s), if any, is output as a list. The second course that may be taken is block 1010, where a form(s) is generated identifying each output for each interaction. Which course is taken can be identified in a variety of manners, such as included in the request received in block 1002, pre-programmed within the testing and form generation module, a preference of the testing and form generation module set by the tester, and so forth.

Although illustrated as two separate processes, it should be noted that the testing and/or form generation for inputs (illustrated in FIG. 9) and outputs (illustrated in FIG. 10) may be combined. For example, a single request may be received requesting both testing and/or for generation for inputs as well as outputs. The blocks of the two processes may be combined into a single process, the two processes may run concurrently, the two processes may run consecutively, and so on.

The inputs and outputs of the business logic are predominately discussed herein with reference to visual forms (e.g., forms that are displayed to a user). The systems and processes described herein, however, can be implemented to present information in any of a wide variety of manners. For example, the inputs (and outputs) may be provided (and presented) audibly rather than visually using a microphone (and speaker).

Conclusion

The discussions herein are directed primarily to software modules and components. Alternatively, the systems and processes described herein can be implemented in other manners, such as firmware or hardware, or combinations of software, firmware, and hardware. By way of example, one or more Application Specific Integrated Circuits (ASICs) or Programmable Logic Devices (PLDs) could be configured to implement selected components or modules discussed herein.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
accessing a computer program;
automatically identifying a set of one or more attributes of the computer program with values that are to be input to the computer program by a user; and
outputting an identification of the set of one or more attributes.

2. A method as recited in claim 1, wherein outputting the identification comprises generating a list including the set of one or more attributes and outputting the list.

3. A method as recited in claim 1, wherein outputting the identification comprises creating one or more forms including selected ones of the set of one or more attributes.

4. A method as recited in claim 3, wherein the one or more forms comprises one or more HyperText Markup Language (HTML) pages.

5. A method as recited in claim 3, wherein the one or more forms comprises one or more eXtensible Markup Language (XML) pages.

6. A method as recited in claim 3, wherein creating the one or more forms comprises generating a form definition for each form by:
identifying the selected one or more attributes to include on the form;
creating a data input field for the form definition via which a user can subsequently input a value for the attribute; and
creating a submit tag for the form definition via which the user can subsequently input a request to submit the values on the form to the computer program.

7. A method as recited in claim 3, wherein the computer program includes a plurality of interactions that each include one or more command definitions and one or more view definitions, wherein each command definition defines a command having various attributes and a behavior, wherein each view definition defines a view that is a response to a request, and wherein the creating comprises creating one form for each of the plurality of interactions.

8. A method as recited in claim 1, further comprising:
identifying a set of one or more outputs of the computer program; and
outputting the set of one or more outputs.

9. A method as recited in claim 8, wherein outputting the set of one or more outputs comprises generating a list including the set of one or more outputs and outputting the list.

10. A method as recited in claim 8, wherein outputting the set of one or more outputs comprises creating one or more forms including selected ones of the set of one or more outputs.

11. A method as recited in claim 1, wherein the computer program includes a plurality of interactions that each include one or more command definitions and one or more view definitions, wherein each command definition defines a command having various attributes and a behavior, and wherein each view definition defines a view that is a response to a request; and
wherein the automatically identifying comprises,
identifying, for each of the command definitions of each of the plurality of interactions, the methods of the command definition,
checking, for each identified method that sets a value, whether a corresponding identified method obtains the value, and
identifying, as an attribute of the set of one or more attributes, each attribute corresponding to a method that sets a value for the attribute for which there is no corresponding identified method that obtains the value for the attribute.

12. A method as recited in claim 11, wherein identifying the methods of the command definition comprises querying the command definition to cause the command definition to identify its own methods.

13. A method as recited in claim 11, further comprising identifying one or more additional attributes that are not obtained by the computer program from elsewhere and that cannot be input by the user.

14. A method comprising:
accessing a computer program;
automatically identifying a set of one or more outputs of the computer program; and
outputting an identification of the set of one or more outputs.

15. A method as recited in claim 14, further comprising:
automatically identifying a set of one or more attributes of the computer program with values that are to be input to the computer program by a user; and
outputting an identification of the set of one or more attributes.

16. A method as recited in claim 14, wherein outputting the identification of the set of one or more outputs comprises generating a list identifying the set of one or more outputs and outputting the list.

17. A method as recited in claim 14, wherein outputting the identification of the set of one or more outputs comprises creating one or more forms including selected ones of the set of one or more outputs.

18. A method as recited in claim 14, wherein the computer program includes a plurality of interactions that each include one or more view definitions, wherein each view definition defines a view that is a response to a request; and
wherein the automatically identifying comprises,
identifying, for each of the view definitions of each of the plurality of interactions, the methods of the view definition,
identifying, as one of the set of one or more outputs, each output included in one of the identified methods.

19. A method as recited in claim 14, wherein the computer program includes a plurality of interactions that each include one or more command definitions and one or more view definitions, wherein each command definition defines a command having various attributes and a behavior, wherein each view definition defines a view that is a response to a request, wherein the outputting comprises creating a form for each of the plurality of interactions, and wherein each form includes one or more outputs for the corresponding one of the plurality of interactions.

20. A system comprising:
a query control module configured to access a business logic and obtain an indication of a plurality of methods used by the business logic; and
a test module configured to analyze the plurality of methods and identify, based on the analysis, a group of one or more attributes with values set by user inputs to the business logic.

21. A system as recited in claim 20, further comprising a filter module configured to:
receive an indication of the plurality of methods used by the business logic;
identify a group of the plurality of methods, wherein each method in the group stores an attribute value or loads an attribute value; and
forward an indication of only the plurality of methods in the group to the test module as the plurality of methods to be analyzed by the test module.

22. A system as recited in claim 20, further comprising a form creation module to create, based on the group of one or more attributes identified by the test module, one or more forms including selected ones of the group of one or more attributes.

23. A system as recited in claim 22, wherein the form creation module is further configured to create the one or more forms by generating a form definition for each form by:
identifying the selected one or more attributes to include on the form;
creating a data input field for the form definition via which a user can subsequently input a value for the attribute; and
creating a submit tag for the form definition via which the user can subsequently input a request to submit the values on the form to the business logic.

24. A system as recited in claim 20, wherein the test module is further configured to output a list including the group of one or more attributes.

25. A system as recited in claim 20, wherein the test module is further configured to:
identify a set of one or more outputs of the business logic; and
output the set of one or more outputs.

26. A system as recited in claim 25, wherein the test module is further configured to output the set of one or more outputs by generating a list including the set of one or more outputs and outputting the list.

27. A system as recited in claim 25, wherein the test module is further configured to output the set of one or more outputs by creating one or more forms including selected ones of the set of one or more outputs.

28. A system as recited in claim 20, wherein the business logic includes a plurality of interactions that each include one or more command definitions and one or more view definitions, wherein each command definition defines a command having various attributes and a behavior, and wherein each view definition defines a view that is a response to a request; and
wherein the query control module is further configured to obtain the indication of the plurality of methods used by the business logic by querying each of the command definitions of each of the plurality of interactions for the methods of the command definition.

29. A system as recited in claim 20, wherein the test module is further configured to identify, based on the analysis of the plurality of methods, one or more additional attributes that are not obtained by the business logic from elsewhere and that cannot be input by a user.

30. One or more computer-readable media comprising computer-executable instructions that, when executed, direct a processor to generate a plurality of input forms and output forms for a computer program by:
accessing the computer program to identify operations in the computer program that load attribute values and set attribute values;
analyzing the identified operations to determine one or more user inputs to the computer program;
automatically generating one or more input forms to allow a user to input at least some of the one or more user inputs;
accessing the computer program to identify one or more outputs of the computer program; and
automatically generating one or more output forms to present the outputs of the computer program.

31. One or more computer-readable media as recited in claim 30, wherein the computer-executable instructions further direct the processor to:
generate a list identifying the one or more user inputs to the computer program and another list identifying the one or more outputs of the computer program; and
output the lists.

32. One or more computer-readable media as recited in claim 30, wherein generating the one or more input forms comprises generating a form definition for each form by:
identifying the selected one or more user inputs to include on the form;
creating data input fields for the form definition via which a user can subsequently input a value for the user inputs; and
creating a submit tag for the form definition via which the user can subsequently input a request to submit the values on the form to the computer program.

33. One or more computer-readable media as recited in claim 30, wherein the computer program includes a plurality of interactions that each include one or more command definitions and one or more view definitions, wherein each command definition defines a command having various attributes and a behavior, and wherein each view definition defines a view that is a response to a request; and
wherein accessing the computer program to identifying operations in the computer program that load attribute values and set attribute values, and analyzing the identified operations,
identifying, for each of the command definitions of each of the plurality of interactions, the methods of the command definition,
checking, for each identified method that sets a value, whether a corresponding identified method obtains the value, and
identifying, as one of the one or more user inputs, each attribute corresponding to a method that sets a value for the attribute for which there is no corresponding identified method that obtains the value for the attribute.

34. One or more computer-readable media as recited in claim 30, wherein the computer-executable instructions further direct the processor to identify one or more attributes of the computer program that are not obtained by the computer program from elsewhere and that cannot be user inputs.

35. A testing system to test a computer program, the testing system comprising:
a query control module configured to identify one or more methods used by the computer program to load attribute values and set attribute values;
a test module configured to identify whether any of the attributes values are set by the computer program prior to being loaded by the computer program, and indicate an error in the computer program if both one or more attribute values are set by the computer program prior to being loaded by the computer program and if the one or more attribute values cannot be input by a user via an input form.

36. A system as recited in claim 35, wherein the computer program includes a plurality of interactions that each include one or more command definitions and one or more view definitions, wherein each command definition defines a command having various attributes and a behavior, and wherein each view definition defines a view that is a response to a request; and
wherein the query control module is further configured to obtain the indication of the plurality of methods used by the computer program by querying each of the command definitions of each of the plurality of interactions for the methods of the command definition.
